(19) United States
(12) Patent Application Publication
(10) Pub. No.: US 2011/0158555 A1
(43) Pub. Date: Jun. 30, 2011

(54) CURVED SURFACE AREA CALCULATION DEVICE AND METHOD

(75) Inventors: CHIH-KUANG CHANG, Tu-Cheng (TW); XIN-YUAN WU, Shenzhen City (CN); XIAO-CHAO SUN, Shenzhen City (CN); JIN-BO HU, Shenzhen City (CN); MIN WANG, Shenzhen City (CN)

(73) Assignees: HONG FU JIN PRECISION INDUSTRY (ShenZhen) CO., LTD, Shenzhen City (CN); HON HAI PRECISON INDUSTRY CO., LTD., Tu-Cheng (TW)

(21) Appl. No.: 12/824,239

(22) Filed: Jun. 28, 2010

(30) Foreign Application Priority Data
Dec. 28, 2009 (CN) 200910312349.8

(51) Int. Cl. G06K 9/36

(52) U.S. Cl. 382/286

(57) ABSTRACT

A curved surface area calculation device and method generates a contour curve consisting of border points of a curved surface, and determines an approximate poly-line of the contour curve in a parametric plane. An approximate polygon of the approximate poly-line is generated according to vertices of the approximate poly-line and preset sample points. The approximate polygon is further meshed by a plurality of triangles. An area of the curved surface is calculated according to the plurality of triangles.

### BACKGROUND

1. Technical Field

Embodiments of the present disclosure relates to computer aided design systems and methods, and more particularly, to a curved surface area calculation device and method.

2. Description of Related Art

In computer aided designs, length information and area information are basic attributes of graphs. For two dimensional graphs and regular three-dimensional (3D) graphs, the length information and area information can be obtained through four arithmetic operations. However, for irregular 3D graphs, such as curved surfaces, which are defined by control points and border points, the area information cannot be obtained through common arithmetic operations.

### BRIEF DESCRIPTION OF THE DRAWINGS

FIG. 1 is a block diagram of one embodiment of a curved surface area calculation device comprising a curved surface area calculation unit.

FIG. 2 is a flowchart of one embodiment of a curved surface area calculation method.

FIG. 3 is a detailed description of block S201 in FIG. 2.

FIG. 4 is a detailed description of block S203 in FIG. 2.

FIG. 5 is a detailed description of block S205 in FIG. 2.

FIG. 6 gives an example for determining vertices of a poly-line.

FIG. 7 illustrates sample points, vertices of a poly-line, and intersection points in a parametric plane.

FIG. 8 and FIG. 9 illustrates generating triangles by connecting sample points, vertices of a poly-line, and intersection points in a parametric plane.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

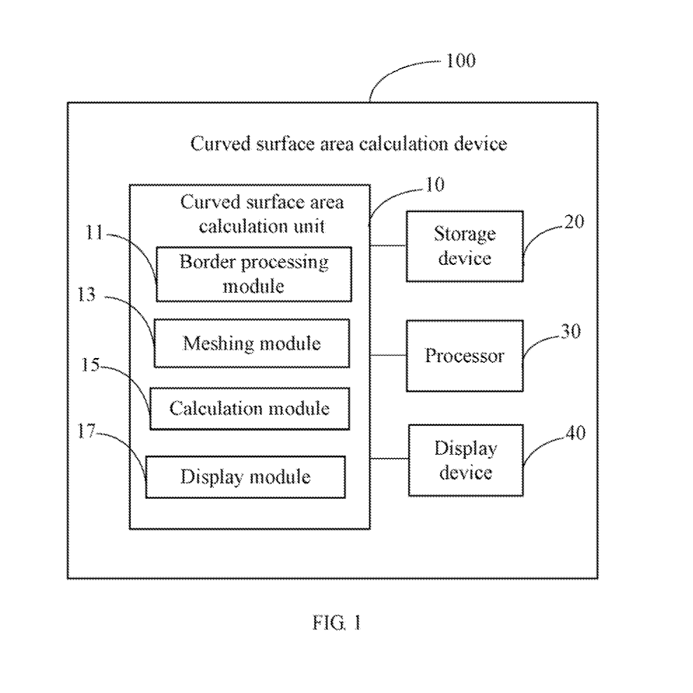

FIG. 1 is a block diagram of one embodiment of a curved surface area calculation device 100. In one embodiment, the curved surface area calculation device 100 may include a curved surface area calculation unit 10, a storage device 20, a processor 30, and a display device 40. In one embodiment, the curved surface area calculation unit 10 creates a two-dimensional (2D) triangle mesh of a curved surface, and calculates an area of the curved surface according to triangles of the 2D triangle mesh. One or more computerized codes of the curved surface area calculation unit 10 are stored in the storage device 20 and executed by the processor 30. The display device 40 displays a calculation result of the curved surface area calculation unit 10 to a user.

In one embodiment, the storage device 20 may be a magnetic or an optical storage device, such as a hard disk drive, an optical drive, or a tape drive. The storage device 20 also stores information of the curved surface, such as border points, control points, and parametric equations of the curved surface. The display device 40 may be a display screen, such as a liquid crystal display (LCD) or a cathode-ray tube (CRT) display.

In one embodiment, as shown in FIG. 1, the curved surface area calculation unit 10 includes a border processing module 11, a meshing module 13, a calculation module 15, and a display module 17.

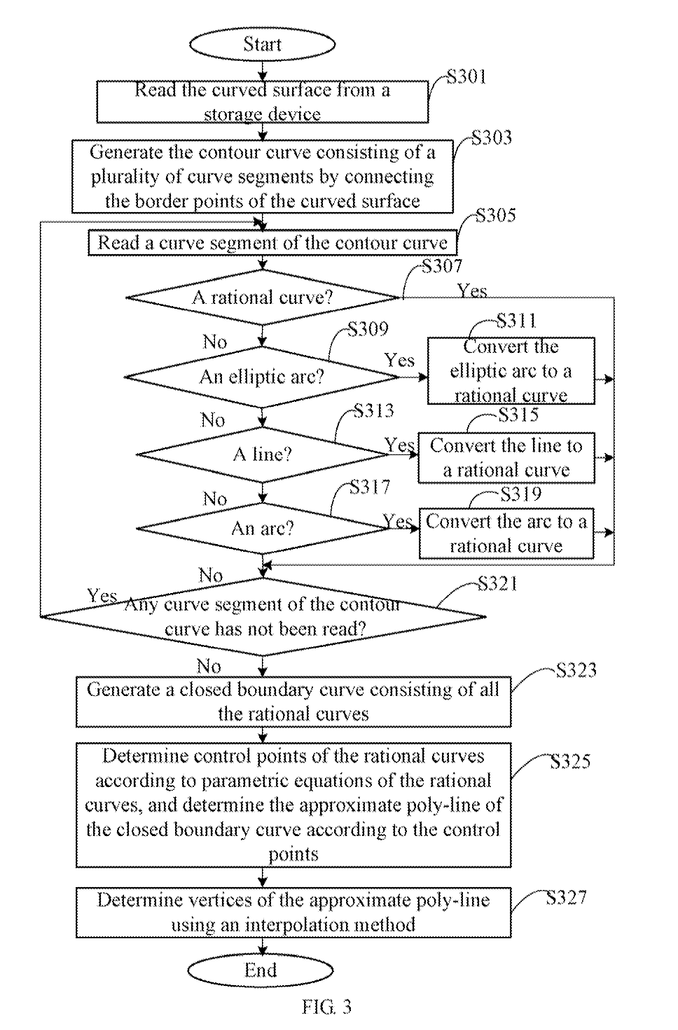

The border processing module 11 generates a contour curve consisting of border points of the curved surface, and determines an approximate poly-line of the contour curve in a parametric plane. A detailed description is given in FIG. 3. The curved surface can consist of a plurality of connected points representative of a physical object, or part/section of the physical object, such as a mobile phone casing, for example.

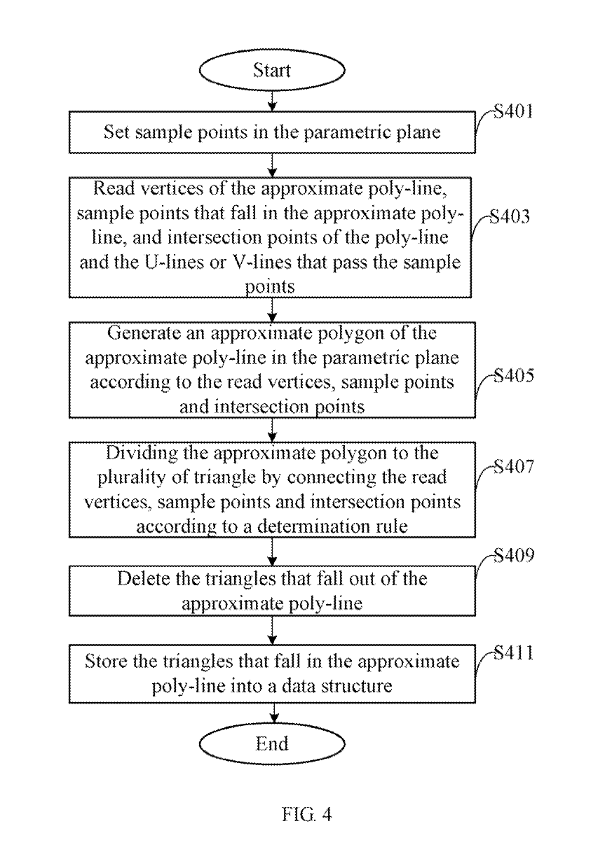

The meshing module 13 sets sample points in the parametric plane, determines an approximate polygon of the contour curve according to the sample points, vertices of the approximate poly-line, and intersection points of vertical lines (or horizontal lines) and the approximate poly-line, and meshes the approximate polygon by a plurality of triangles. A detailed description is given in FIG. 4.

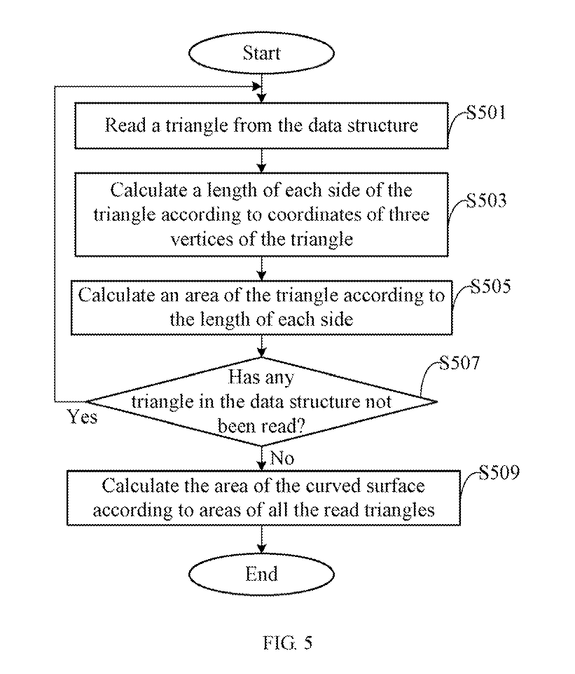

The calculation module 15 calculates the area of the curved surface according to areas of the plurality of triangles. A detailed description is given in FIG. 5.

The display module 17 displays the curved surface, all the triangles in the parametric plane, and the calculated area of the curved surface on the display device 40.

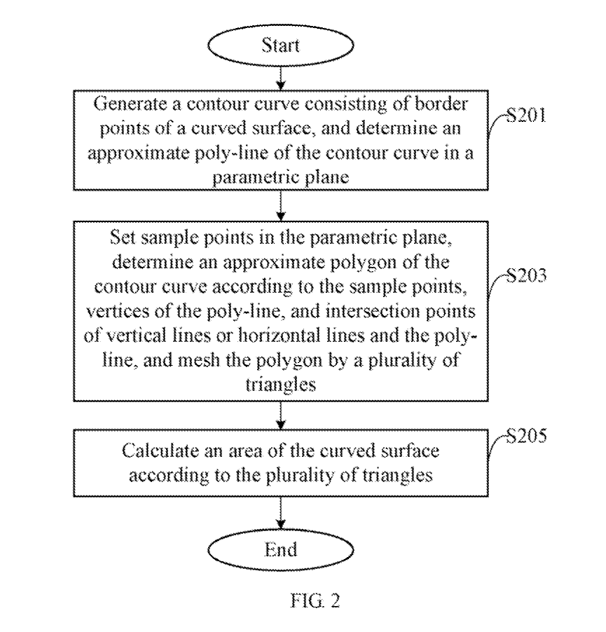

FIG. 2 is a flowchart of one embodiment of a curved surface area calculation method. Depending on the embodiment, additional blocks may be added, others removed, and the ordering of the blocks may be changed.

In block S201, the border processing module 11 generates a contour curve consisting of border points of the curved surface, and determines an approximate poly-line of the contour curve in a parametric plane (a detailed description is given in FIG. 3). The display module 17 displays the curved surface, the contour curve, the approximate poly-line, and the parametric plane on the display device 40.

In block S203, the meshing module 13 sets sample points in the parametric plane, determines an approximate polygon of the contour curve according to the sample points, vertices of the poly-line, and intersection points of vertical lines (or horizontal lines) and the poly-line, and meshes the approximate polygon by a plurality of triangles (a detailed description is given in FIG. 4). The display module 17 displays the sample points, the vertices of the poly-line, the intersection points, the approximate polygon, and all the triangles on the display device 40.

In block S205, the calculation module 15 calculates the area of the curved surface according to areas of the plurality of triangles (a detailed description is given in FIG. 5). The display module 17 displays the area of the curved surface on the display device 40.

FIG. 3 is a detailed description of block S201 in FIG. 2. Depending on the embodiment, additional blocks may be added, others removed, and the ordering of the blocks may be changed.

In block S301, the border processing module 11 reads the curved surface from the storage device 20.

In block S303, the border processing module 11 generates the contour curve consisting of a plurality of curve segments by connecting the border points of the curved surface.

In block S305, the border processing module 11 reads a curve segment of the contour curve.

In block S307, the border processing module 11 checks if the read curve segment is a rational curve. If the read curve segment is a rational curve, the procedure directly goes to block S321. Otherwise, if the read curve segment is not a rational curve, the procedure goes to block S309. It is understood that the plurality of curve segments of the contour curve may include lines, arcs, elliptic arcs, and rational curves, where the rational curves approaches the contour curve of the curved surface.

In block S309, the border processing module 11 checks if the read curve segment is an elliptic arc. If the read curve segment is an elliptic arc, in block S311, the border processing module 11 converts the elliptic arc to a rational curve. Otherwise, if the read curve segment is not an elliptic arc, the procedure goes to block S313.

In block S313, the border processing module 11 checks if the read curve is a line. If the read curve segment is a line, in block S315, the processing module 11 converts the line to a rational curve. Otherwise, if the read curve segment is not a line, the procedure goes to block S317.

In block S317, the border processing module 11 checks if the read curve segment is an arc. If the read curve segment is an arc, in block S319, the processing module 11 converts the arc segment to a rational curve. Otherwise, if the read curve segment is not an arc, the procedure goes to block S321.

In block S321, the border processing module 11 checks if there is any curve segment of the contour curve has not been read. If there is any curve segment of the contour curve has not been read, the procedure repeats from block S305, until all curve segments of the contour curve have been read and converted to rational curves, the procedure goes to block S323.

In block S323, the border processing module 11 generates a closed boundary curve consisting of all the rational curves. It is understood that converting other types of curves to rational curves can not only make the generated closed boundary curve approach the contour line, but also improve following processing speeds since there is only one type of curve (i.e., the rational curve) to be processed.

In block S325, the border processing module 11 determines control points of the rational curves according to parametric equations of the rational curves, and determines the approximate poly-line of the closed boundary curve according to the control points. It is understood that each rational curve has a corresponding parametric equation represented by parameters such as “U” and “V,” where a value of U or V falls in an interval (0, 1), and control points of each rational curve can be determined according to the corresponding parametric equation.

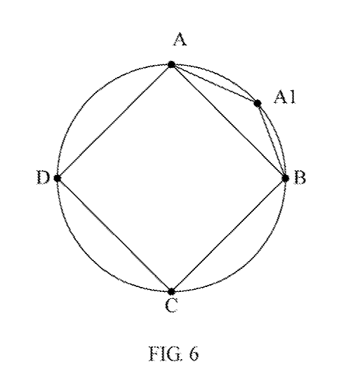

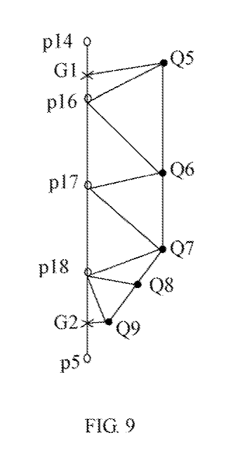

In block S327, the border processing module 11 determines vertices of the approximate poly-line in the parametric plane using a mathematical method (e.g., an interpolation method). In one embodiment, a horizontal direction of the parametric plane is represented by “U,” a vertical direction of the parametric plane is represented by “V,” and each point in the parametric plane can be represented by (U, V), which corresponds to 2D coordinates (X, Y), where the value of U or V falls in the interval (0, 1). For example, supposing the circle is the closed boundary curve, the border processing module 11 connects four points A, B, C, and D on the circle to generate a poly-line. However, the poly-line is far from the circle, that is, the poly-line has a bad approach precision with the circle. To improve the approach precision, more vertices should be determined. For example, if the interpolation method is applied, midpoints between each two vertices of the poly-line can be obtained as new vertices of the poly-line. The more vertices of the poly-line are determined, the higher approach precision the poly-line has. It should be understood that, the poly-lines illustrated in FIG. 6˜FIG. 9 only consists of segment lines for giving simple examples, in fact, a poly-line may consist of segment lines and arcs.

FIG. 4 is a detailed description of block S203 in FIG. 2. Depending on the embodiment, additional blocks may be added, others removed, and the ordering of the blocks may be changed.

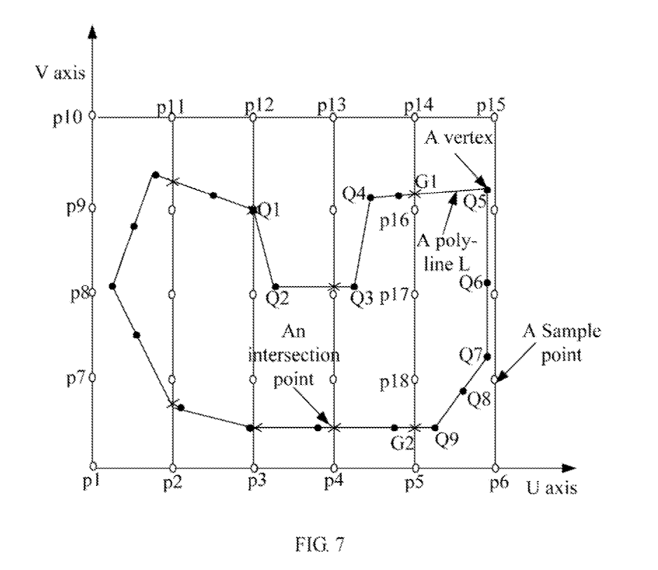

In block S401, the meshing module 13 sets sample points in the parametric plane. For example, as shown in FIG. 7, the meshing module 13 averagely divides the U axis to five segments to obtain six sample points p1˜p6, and averagely divides the V axis to four segments to obtain five sample points pl and p7˜p10. As a result, as shown in FIG. 7, each of six V-lines “p1p10,” “p2p11,” “p3p12,” “p4p13,” “p5p14” and “p6p15,” which pass the six sample points p1˜p6, has five sample points represented by hollow spheres.

In block S403, the meshing module 13 reads vertices of the approximate poly-line, sample points that fall in the approximate poly-line, and intersection points of the poly-line and the U-lines or V-lines that pass the sample points. For example, as shown in FIG. 7, filled circles, such as the black filled circles labeled by “Q1,” “Q2” are vertices of a poly-line L. The sample points “p16,” “p17,” and “p18” of a V-line “p5p14” fall in the poly-line L. The V-line “p5p14” and the poly-line L has two intersection points “G1” and “G2.”

In block S405, the meshing module 13 generates an approximate polygon of the approximate poly-line in the parametric plane according to the read vertices, sample points, and intersection points.

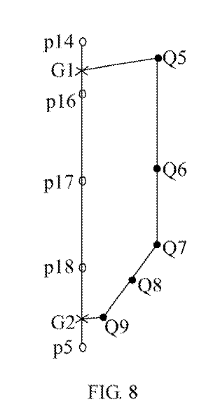

In block S407, the meshing module 13 divides the approximate polygon to obtain the plurality of triangles by connecting the read vertices, sample points, and intersection points according to a determination rule. In this embodiment, the determination rule is that there is no vertices of the polygon falls in a circumcircle of each obtained triangle. FIG. 8 shows a part of the polygon generated in block S405, there are five vertices Q1˜Q5 of the poly-line L, three sample points “p16,” “p17” and “p18” that falls in the poly-line L, and two intersection points “G1” and “G2” of the V-line “p5p14” and the poly-line L. The meshing module 13 connects the ten points to obtain eight triangles shown in FIG. 9.

In block S409, the meshing module 13 deletes the triangles that fall out of the approximate poly-line. For example, if the four vertices “Q1,” “Q2,” “Q3” and “Q4” construct two triangles which fall out of the poly-line L, the two triangles are regarded as ineffective triangles and deleted by the meshing module 13.

In block S411, the meshing module 13 stores all triangles that fall in the approximate poly-line into a data structure stored in the storage device 20.

FIG. 5 is a detailed description of block S205 in FIG. 2. Depending on the embodiment, additional blocks may be added, others removed, and the ordering of the blocks may be changed.

In block S501, the calculation module 15 reads a triangle from the data structure stored in the storage device 20.

In block S503, the calculation module 15 calculates a length of each side of the triangle according to coordinates of three vertices of the triangle.

In block S505, the calculation module 15 calculates an area of the triangle according to the length of each side.

In block S507, the calculation module 15 determines if there is any triangles stored in the data structure has not been read. If there is any triangles stored in the data structure has not been read, the procedure repeats from block S501, until all triangles stored in the data structure have been read, the procedure goes to block S509.

In block S509, the calculation module 15 calculates the area of the curved surface according to areas of all triangles.

Although certain inventive embodiments of the present disclosure have been specifically described, the present disclosure is not to be construed as being limited thereto. Various changes or modifications may be made to the present disclosure without departing from the scope and spirit of the present disclosure.

1. A curve surface area calculation method, the method comprising:
(a) generating a contour curve consisting of border points of a curved surface according to information of the curved surface stored in a storage device, and determining an approximate poly-line of the contour curve in a parametric plane;
(b) setting sample points in the parametric plane, determining an approximate polygon of the contour curve according to the sample points, vertices of the approximate poly-line, and intersection points of vertical lines or horizontal lines and the approximate poly-line, and meshing the approximate polygon by a plurality of triangles; and
(c) calculating the area of the curved surface according to areas of the plurality of triangles.

2. The method as claimed in claim 1, wherein the storage device is selected from the group consisting of a hard disk drive, an optical drive, and a tape drive.

3. The method as claimed in claim 1, wherein block (a) comprises:
(a1) reading the curved surface from the storage device;
(a2) generating the contour curve consisting of a plurality of curve segments by connecting the border points of the curved surface;
(a3) converting all curve segments of the contour curve to rational curves and generating a closed boundary curve consisting of all the rational curves;
(a4) determining control points of the rational curves according to parametric equations of the rational curves, and determining the approximate poly-line of the closed boundary curve according to the control points; and
(a5) determining vertices of the approximate poly-line in the parametric plane using a mathematical method.

4. The method as claimed in claim 3, wherein the mathematical method is an interpolation method.

5. The method as claimed in claim 3, wherein block (b) comprises:
(b1) dividing a horizontal axis and a vertical axis of the parametric plane by horizontal lines and vertical lines, so as to obtain the sample points;
(b2) reading vertices of the approximate poly-line, sample points that fall in the approximate poly-line, and intersection points of the approximate poly-line and the horizontal lines or vertical lines that pass the sample points;
(b3) generating the approximate polygon of the approximate poly-line in the parametric plane according to the read vertices, sample points, and intersection points; and
(b4) dividing the approximate polygon to obtain the plurality of triangles by connecting the read vertices, sample points, and intersection points according to a determination rule.

6. The method as claimed in claim 5, wherein the determination rule is that there is no vertex of the approximate polygon that falls in a circumcircle of each obtained triangle.

7. The method as claimed in claim 5, wherein block (b) further comprises:
(b5) deleting the triangles that fall out of the approximate poly-line; and
(b6) storing all triangles that fall in the approximate poly-line into a data structure stored in the storage device.

8. The method as claimed in claim 7, wherein block (c) comprises:
(c1) calculating lengths of three sides of each triangle stored in the data structure according to coordinates of three vertices of the triangle;
(c2) calculating an area of each triangle stored in the data structure according to the lengths of three sides of the triangle; and
(c3) calculating the area of the curved surface by totalizing areas of all the triangles stored in the data structure.

9. A storage medium storing a set of instructions, the set of instructions capable of being executed by a processor to perform a curve surface area calculation method, the method comprising:
(a) generating a contour curve consisting of border points of a curved surface according to information of the curved surface, and determining an approximate poly-line of the contour curve in a parametric plane;
(b) setting sample points in the parametric plane, determining an approximate polygon of the contour curve according to the sample points, vertices of the approximate poly-line, and intersection points of vertical lines or horizontal lines and the approximate poly-line, and meshing the approximate polygon by a plurality of triangles; and
(c) calculating the area of the curved surface according to areas of the plurality of triangles.

10. The storage medium as claimed in claim 9, wherein block (a) comprises:
(a1) reading the curved surface from the storage medium;
(a2) generating the contour curve consisting of a plurality of curve segments by connecting the border points of the curved surface;
(a3) converting all curve segments of the contour curve to rational curves and generating a closed boundary curve consisting of all the rational curves;
(a4) determining control points of the rational curves according to parametric equations of the rational curves, and determining the approximate poly-line of the closed boundary curve according to the control points; and
(a5) determining vertices of the approximate poly-line in the parametric plane using an interpolation method.

11. The storage medium as claimed in claim 10, wherein block (b) comprises:
(b1) dividing a horizontal axis and a vertical axis of the parametric plane by horizontal lines and vertical lines, so as to obtain the sample points;
(b2) reading vertices of the approximate poly-line, sample points that fall in the approximate poly-line, and intersection points of the poly-line and the horizontal lines or vertical lines that pass the sample points;
(b3) generating the approximate polygon of the approximate poly-line in the parametric plane according to the read vertices, sample points, and intersection points; and
(b4) dividing the approximate polygon to obtain a plurality of triangles by connecting the read vertices, sample points, and intersection points according to a determination rule.

12. The storage medium as claimed in claim 11, wherein block (b) further comprises:
(b5) deleting the triangles that fall out of the approximate poly-line; and
(b6) storing all triangles that fall in the approximate poly-line into a data structure stored in the storage medium.

13. The storage medium as claimed in claim 12, wherein block (c) comprises:
(c1) calculating lengths of three sides of each triangle stored in the data structure according to coordinates of three vertices of the triangle;
(c2) calculating an area of each triangle stored in the data structure according to the lengths of three sides of the triangle; and
(c3) calculating the area of the curved surface by totalizing areas of all the triangles stored in the data structure.

14. A curved surface area calculation device, comprising:
a storage device;
at least one processor; and
a curved surface area calculation unit being stored in the storage device and executable by the at least one processor, the curved surface area calculation unit comprising:
a border processing module operable to generate a contour curve consisting of border points of the curved surface, and determine an approximate poly-line of the contour curve in a parametric plane;
a meshing module operable to set sample points in the parametric plane, determine an approximate polygon of the approximate poly-line according to the sample points, vertices of the approximate poly-line, and intersection points of vertical lines or horizontal lines and the approximate poly-line, and mesh the approximate polygon by a plurality of triangles; and
a calculation module operable to calculate the area of the curved surface according to areas of the plurality of triangles.

15. The device as claimed in claim 14, wherein the curved surface area calculation unit further comprises a display module operable to display the calculation result on a display device.

16. The device as claimed in claim 14, wherein the storage device is selected from the group consisting of a hard disk drive, an optical drive, and a tape drive.

17. The device as claimed in claim 14, wherein the approximate poly-line of the contour curve is determined as follows:
converting all curve segments of the contour curve to rational curves and generating a closed boundary curve consisting of all the rational curves;
determining control points of the rational curves according to parametric equations of the rational curves; and
determining the approximate poly-line of the closed boundary curve according to the control points.

18. The device as claimed in claim 14, wherein the sample points are set by dividing a horizontal axis and a vertical axis of the parametric plane by a plurality of horizontal lines and vertical lines.

19. The device as claimed in claim 14, wherein the plurality of triangles are obtained by connecting the read vertices, sample points, and intersection points according to a determination rule.

20. The device as claimed in claim 19, wherein the meshing module is further operable to delete the triangles that fall out of the approximate poly-line, and store the triangles that fall in the approximate poly-line into a data structure stored in the storage device.

21. The device as claimed in claim 20, wherein the calculation module calculates the area of the curved surface according to an area of each triangle stored in the data structure.
